(19) United States
(12) Patent Application Publication
(10) Pub. No.: US 2013/0107077 A1
(43) Pub. Date: May 2, 2013

(54) PHOTOGRAPH MANAGEMENT METHOD AND ELECTRONIC DEVICE WITH CAMERA USING SAME

(71) Applicant: YU-CUI ZHOU, Shenzhen City (CN)

(72) Inventor: YU-CUI ZHOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/477,070

(22) Filed: May 22, 2012

(30) Foreign Application Priority Data
Oct. 31, 2011 (CN) 201110337506.8

(51) Int. Cl. H04N 5/76

(52) U.S. Cl. 348/231.2; 348/E05.024

(57) ABSTRACT

An electronic device includes a storage unit, a camera unit, and a photograph managing module. The storage unit stores a plurality of photo documents having different document names. The document name of each photo document corresponds to a plurality of photograph styles. The camera unit captures a first photograph having a first photograph style which is selected from the plurality of photograph styles. The photograph managing module selects one of the photo documents according to the first photograph style and stores the first photograph into the selected one of the photo documents.

### TECHNICAL FIELD

The present disclosure relates to a photograph management method and an electronic device with camera using the photograph management method.

### DESCRIPTION OF RELATED ART

Electronic devices equipped with cameras such as mobile phones or portable computer are widely used. Typically, the electronic devices take photographs and store the photographs into a memory for playback or printing. These photographs are automatically stored in a same document in the memory at the moment the photographs are taken. However, it is inconvenient for a user to seek one photograph amongst the growing collection of new photographs.

Thus, an electronic device having a function to overcome the above-described shortcomings is desired.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram illustrating one embodiment of an electronic device in accordance with present disclosure.

FIG. 2 is a flowchart of a first embodiment of a photograph management method using the electronic device of FIG. 1.

FIG. 3 is a flowchart of a second embodiment of a photograph management method using the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any tpye of non-transitory computer-readable medium or other storage device. Some non-limiting examples of non-transitory computer-readable medium include CDs, DVDs, BLU-RAY, flash memory, and hard disk drives.

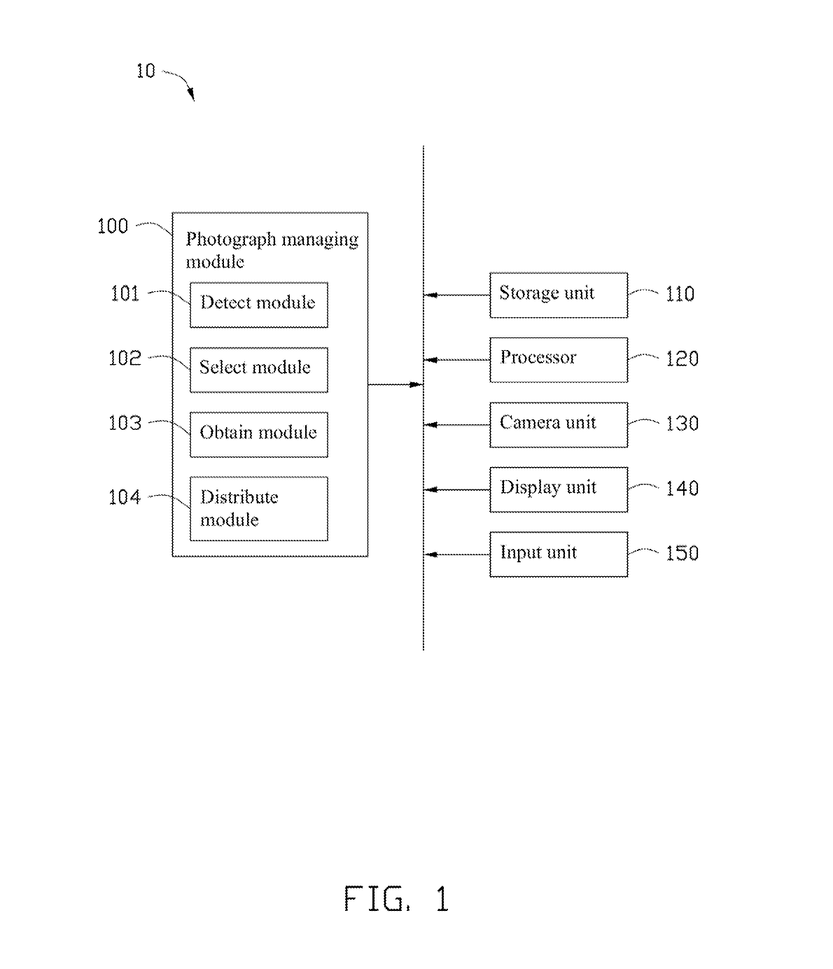

FIG. 1 is schematic block diagram illustrating one embodiment of an electronic device 10 in accordance with present disclosure. The electronic device 10 includes a photograph managing module 100, a storage unit 110, a processor 120, a camera unit 130, a display unit 140, and an input unit 150. The electronic device 10 may be a mobile phone, a portable computer, a personal media player. In the embodiment, the electronic device 10 is a mobile phone. FIG. 1 shows one example of the electronic device 10, and the electronic device 10 can include more or fewer components than those shown in the embodiment, or have the various components in a different configuration.

The input device 150 is configured for a user to input messages or instructions to control operations of the electronic device 10, for example, to start up the camera unit 130 to take photograph. In one embodiment, the input device 150 may be a keypad or a touch panel.

The storage unit 110 is configured to store the photographs generated by the camera unit 130. In the embodiment, the storage unit 110 includes a plurality of photo documents having different document names to store the photographs. The document name of each photo document corresponds to the photograph date and/or styles of the photographs. In one embodiment, the styles of the photograph include animals, people, plants, scenery, foods, and architecture. For example, the plurality of photo documents may include documents selected from the group consisting of animals, people, plants, sceneries, food, and architecture. In one alternative embodiment, at least one of the photo documents further includes a plurality of sub-documents having a name that corresponds to a date of the photograph and/or styles of the photographs.

In one embodiment, the storage unit 110 may be a random access memory for temporary storage of information, and/or a read only memory for permanent storage of information. In other embodiments, the storage unit 110 may also be an external storage device, such as a hard disk, a storage card, or a data storage medium.

The display unit 140 is configured to display operation interface to be processed by user or one or more photographs which are received from the storage unit 110 or the camera unit 130.

The photograph managing module 100 controls the processor 120 to receive the photographs captured by the camera unit 130, and stores the photographs into the different photo documents in response to a current date and/or a style of each photograph. In the embodiment, the photograph managing module 100 includes a detect module 101, a select module 102, an obtain module 103, and a distribute module 104.

The detect module 101 is used to detect if the electronic device 10 enters a photo capture mode, in other words, to detect if the camera unit 130 starts and is prepared to take a photograph. In alternative embodiment, the detect module 101 is also configured to detect or determine a style of each photograph taken by the camera unit 130, and provide a photograph style of each photograph to the select module 102.

The select module 102 controls the processor 120 to pre-create the different photo documents and/or sub-documents with different document name into the storage unit 110. In one embodiment, the different photo documents and/or sub-documents can be created and named by user using the input unit 150. In one embodiment, the different photo documents and/or sub-documents can be automatically created and named in accordance with the current date and/or the received photograph style. In one embodiment, the plurality of photo documents are named by the styles of the photograph and the sub-documents in the photo document are named by the date of which the user took the photograph. In another embodiment, a plurality of the photo documents are named by the date on which the user took the photograph, and the sub-documents in the photo document are named by the styles of the photographs.

The select module 102 is also configured to select one photo document in response to the photograph style of a photograph to be taken or the date on which the user takes photograph. In alternative embodiment, the select module 102 may automatically select one photo document in response to the photograph style received from the detect module 101.

The obtain module 103 is configured to extract each photograph from the camera unit 130, after each photograph is taken or captured by the camera unit 130.

The distribute module 104 is configured to control the processor 120 to store the extracted photograph into the selected one photo document or sub-document.

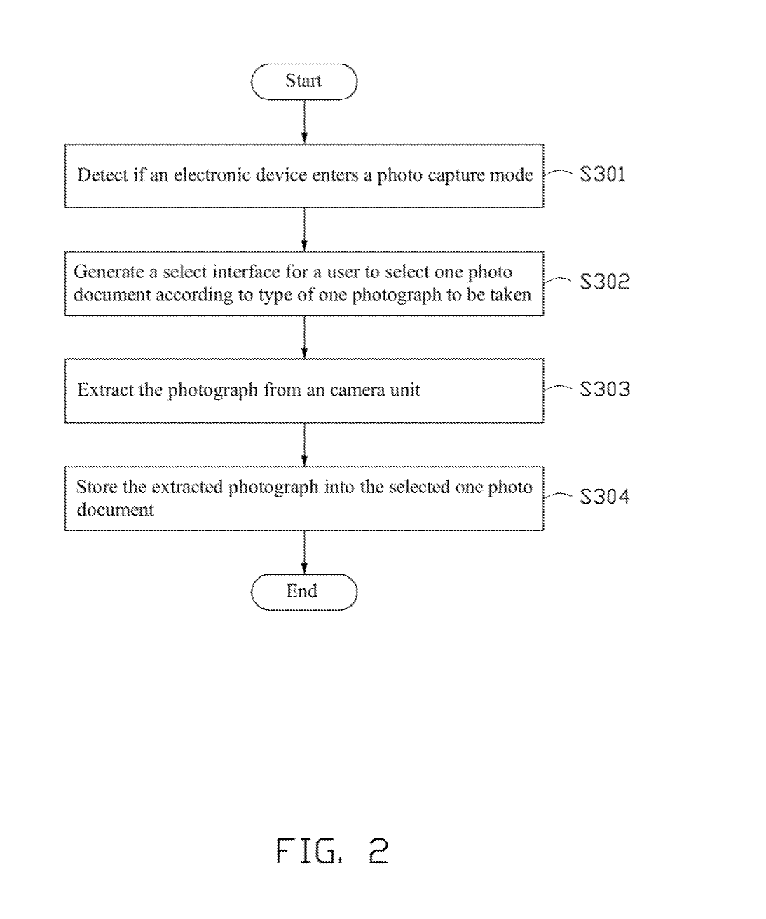

FIG. 2 is a flowchart of a first embodiment of a photograph management method using the electronic device 10. FIG. 2 shows one example of the photograph management method, and the photograph management method can include more or fewer steps than those shown in the embodiment, or have the various steps in a different process.

In step S301, the detect module 101 detects if the electronic device 10 enters a photo capture mode. The detect module 101 generates a detect signal to the select module 102.

In step S302, the select module 102 generates a select interface for a user to select one of the photo documents according to the style of one photograph to be taken. In this embodiment, the photo documents may include documents selected from the group consisting of animals, people, plants, sceneries, food, and architecture. For example, the selected one photo document is an architecture document because the photograph to be taken by the user is a photograph of architecture. In alternative embodiment, the photo documents can be edited, increased or decreased by the user according to need.

In step S303, after the user finished selecting the photo document according to style of one photograph to be taken, the user controls the camera unit 130 to take a photograph. The obtain module 103 extracts the photograph from the camera unit 130.

In step S304, the distribute module 104 stores the extracted photograph into the selected one photo document.

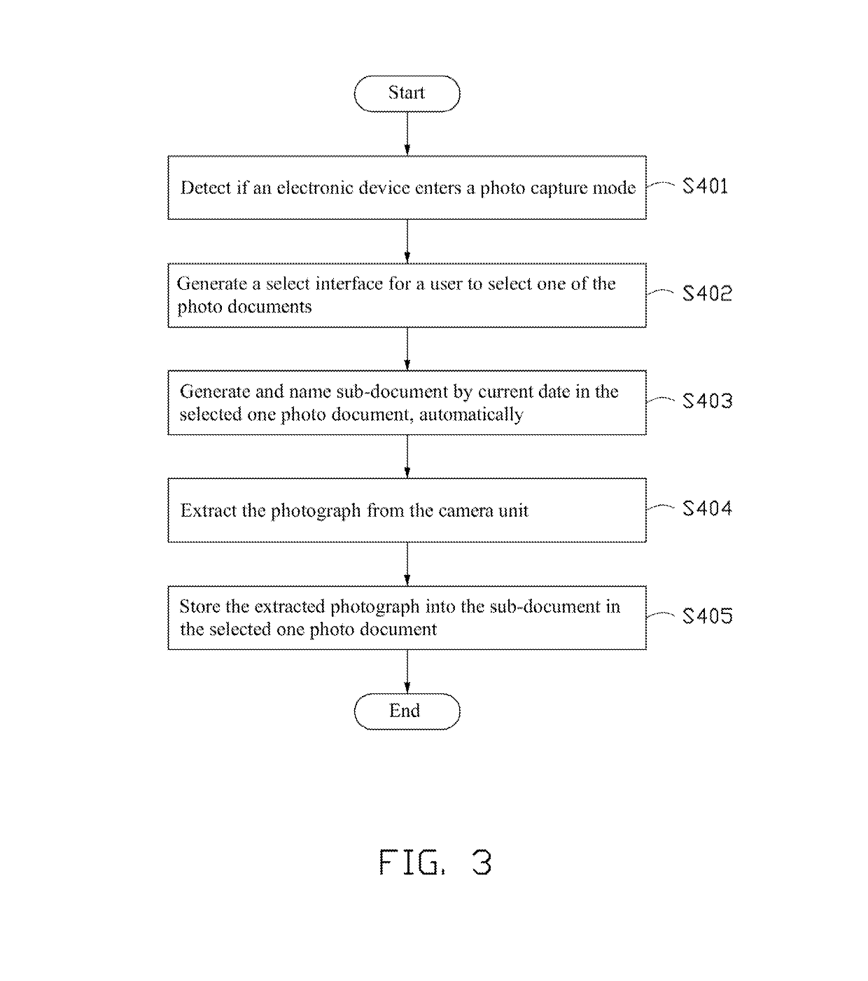

FIG. 3 is a flowchart of a second embodiment of a photograph management method using the electronic device 10. FIG. 3 shows one example of the photograph management method, and the photograph management method can include more or fewer steps than those shown in the embodiment, or have the various steps in a different process.

In step S401, the detect module 101 detects if the electronic device 10 enters a photo capture mode. The detect module 101 generates a detect signal to the select module 102.

In step S402, the select module 102 generates a select interface for a user to select one of the photo documents. In one embodiment, the photo documents may include documents selected from the group consisting of animals, people, plants, sceneries, food, and architecture.

In step S403, the select module 102 controls the processor 120 to automatically generate and name the sub-document by the current date in a selected one photo document when the photo document is selected. Each photo document further includes a sub-document named by the current date.

In step S404, after the user finished selecting the photo document according to style of one photograph to be taken, the user controls the camera unit 130 to take photograph. The obtain module 103 extracts the photograph from the camera unit 130.

In step S405, the distribute module 104 stores the extracted photograph into the sub-document in the selected one photo document.

In alternative embodiment, if the user does not select any photo document in a predetermined time in step 402, the select module 102 controls the processor to automatically generate and name the photo document by current date. In the embodiment, the distribute module 104 stores the extracted photograph into the auto-created photo document named by date.

Even though numerous characteristics and advantages of certain inventive embodiments have been set out in the foregoing description, together with details of the structures and functions of the embodiments, the disclosure is illustrative only; and changes may be made in detail, especially in the matter of arrangement of parts within the principles of present invention to the full extent indicated by the broad general meaning of the terms in which the appended claims are expressed.

What is claimed is:

1. An electronic device, comprising:
a storage unit storing a plurality of photo documents having different document names, the document name of each photo document corresponding to a plurality of photograph styles;
a camera unit capturing a first photograph having a first photograph style selected from the plurality of photograph styles; and
a photograph managing module configured for selecting one of the photo documents according to the first photograph style, and storing the first photograph into the selected one of the photo documents.

2. The electronic device of claim 1, wherein the photograph styles are selected from group consisting of animals, people, plants, sceneries, food, and architecture.

3. The electronic device of claim 1, wherein the photograph managing module comprises a detect module that detects if the electronic device enters a photo capture mode.

4. The electronic device of claim 1, wherein the photograph managing module comprises a detect module that detects if the camera unit starts and is prepared to take a photograph.

5. The electronic device of claim 1, wherein the photograph managing module comprises a detect module that detects the first photograph style of the first photograph.

6. The electronic device of claim 1, wherein the photograph managing module further comprises a select module configured to pre-create the plurality of photo documents and name each photo document corresponding to the plurality of photograph styles.

7. The electronic device of claim 6, wherein the plurality of photo documents are automatically created and named in accordance with the plurality of the photograph styles by the select module.

8. The electronic device of claim 1, wherein at least one of the photo documents further comprises a sub-document for storing the first photograph.

9. The electronic device of claim 8, wherein the sub-document is automatically named by the date on which the first photograph is captured.

10. A photograph management method, comprising:
creating a plurality of photo documents having different document names into a storage unit, the document name of each photo document corresponding to a plurality of photograph styles;
capturing a first photograph having a first photograph style selected from the plurality of photograph styles by a camera unit; and
selecting one of the photo documents according to the first photograph style and storing the first photograph into the selected one of the photo documents by a photograph managing module.

11. The photograph management method of claim 10, wherein the photograph styles are selected from group consisting of animals, people, plants, sceneries, food, and architecture.

12. The photograph management method of claim 10, further comprising detecting if an electronic device enters a photo capture mode.

13. The photograph management method of claim 10, further comprising detecting if the camera unit starts and is prepared to take a photograph.

14. The photograph management method of claim 10, further comprising detecting the first photograph style of the first photograph before selecting one of the photo documents.

15. The photograph management method of claim 10, wherein the plurality of photo documents are automatically created and named in accordance with the plurality of the photograph styles by photograph managing module.

16. The photograph management method of claim 10, further comprising creating a sub-document in the selected one of the photo documents for storing the first photograph.

17. The photograph management method of claim 16, wherein the sub-document is automatically named by the date on which the first photograph is captured.

18. The photograph management method of claim 10, further comprising:
capturing a second photograph having a second photograph style selected from the plurality of photograph styles by the camera unit; and
selecting another one of the photo documents according to the second photograph style and storing the second photograph into the selected another one of the photo documents by the photograph managing module.
